(19) United States
(12) Patent Application Publication
(10) Pub. No.: US 2003/0156016 A1
(43) Pub. Date: Aug. 21, 2003

(54) Device for preventing animal casualties which can be inflicted by a vehicle

(76) Inventors: Stefan Heimburger, Willstaett-Legelshurst (DE); Jochen Moench, Sinzheim (DE)

Correspondence Address: STRIKER, STRIKER & STENBY, 103 East Neck Road, Huntington, NY, 11743, US

(21) Appl. No.: 10/361,397

(22) Filed: Feb. 10, 2003

(30) Foreign Application Priority Data
Feb. 18, 2002 (DE) 102 06 866.6

(51) Int. Cl. B60Q 1/00

(52) U.S. Cl. 340/425.5; 340/468

(57) ABSTRACT

A device for preventing animal casualties from a vehicle, in particular in darkness has a control-and regulating a unit which obtains at least a first input signal and a second input signal, wherein the first input signal indicates a position of a light switch of the vehicle, so that when the position of the light switch is in a high beam position, the control-and regulating device, in response to obtaining the second input signal, turns off a high beam and turns on a low beam.

### BACKGROUND OF THE INVENTION

The present invention relates to a device for preventing animal casualties from a vehicle, in particular during driving in darkness.

Frequently animal casualties in darkness occur as a result of blinding of an animal by a headlight of the approaching vehicle. Because of the blinding by the headlight, the animal remains standing on the road and stares motionless in the headlight of the approaching vehicle. In such situations, the conventional recommendation for the driver is to apply a full braking, to turn off the headlight and to activate the horn. The full braking serves for avoiding the impact or for avoiding an eventual impact speed, the dimming of light must end the blinding of the animal so that it moves from the roadway, and the horn must deter or startle the vehicle so that it leaves the roadway. These three above mentioned actions must be performed by a driver as simultaneous as possible. In such extreme situations however, only a few drivers can act simultaneously, so that frequently only the horn or the brake is applied, while the high beam remains turned on. Thereby the animal stands motionless on the road and animal casualties can be frequently not prevented.

### SUMMARY OF THE INVENTION

Accordingly, it is an object of the present invention a device for preventing animal casualties from a vehicle, which avoids the disadvantages of the prior art.

In keeping with these objects and with others which will become apparent hereinafter, one feature of the present invention resides, briefly stated, in a device for preventing animal casualties from the vehicle, which has a control-and regulating device, which couples at least two input signals.

One of the both input signals is the position of the light switch of the vehicle. When the position of the light switch is in the high beam position and the control-and regulating device detects the second input signal, the high beam is turned off and the low beam is turned on. Therefore the inventive device serves for the operation in which, with a turned on headlight and during occurrence of a second additional activation, the high beam is turned off and the low beam is turned on to end blinding of an animal on the roadway.

Preferably, the second input signal is the position of a horn of the vehicle. The control-and regulating device turns off the high beam and turns on the low beam, when the second input signal indicates the actuation of the horn. When a driving condition of the driving with high beam and the actuation of the horn are provided, an animal with a high probability is on the roadway, so that the inventive device automatically turns off the high beam and turns on the low beam, to end a blinding of the animal.

In accordance with an advantageous embodiment of the present invention, the control-and regulating device obtains a signal of an ABC braking system as a third input signal. The control-and regulating device turns off the high beam and turns on the low beam only when the third input signal indicates a braking in an ABC regulating region of the braking system. With such a combination of conditions or actions by a driver (high beam turned on, horn activated, braking in ABC regulating region) the probability is even higher that an animal is located on the roadway whose blinding by turning-off of the high beam and turning on of the low beam is ended.

In accordance with another preferable embodiment of the invention, the second input signal is preferably the actuation of an ABS brake system. The control-and regulation device turns off the high beam and turns on the low beam, when the second input signal indicates a braking in an ABS regulating region of the braking system or when the braking force applied by the driver through the braking paddle exceeds a predetermined force. The intensity of braking can be detected for example by a force sensor or a path sensor on a braking paddle. With this vehicle condition combination of a turned-on high beam and a braking in the ABS regulating region or a strong braking, also with high probability it is excluded that an animal is located on the roadway. In addition, in such a condition it can be determined that the requirement of actuation of a horn is fulfilled as a third input signal in the control-and regulating device, to turn off the high beam and to turn on the low beam.

In accordance with a further preferable embodiment of the invention, the second input signal is a signal of a radar unit which detects objects located on the roadway. When therefore the radar unit detects objects on the roadway, it provides a signal (second input signal) to the control-and regulating device, so that it automatically turns off the high beam and turns on the low beam. It is to be understood that the above illustrated conditions (braking in ABS regulating region or intense braking, actuation of the horn) in the same way can be combined with the input signal of the radar unit.

Preferably the low beam continuously remains turned on. Thereby it can be prevented when the driver for example no longer activates the horn for performing steering movements, the high beam turns on automatically and thereby the animal will again be blinded on the roadway.

In accordance with a further preferable embodiment of the invention, the control-and regulating unit activates further the horn or an additional acoustic signal transducer. It is especially advantageous when as an additional acoustic signal transducer, a horn is used in an ultrasound region or another special horn to scare an animal.

In order to further scare or frighten the animal on the roadway, the control-and regulating device activates preferably additionally a warning blinking device of the vehicle. Thereby automatically another subsequent traffic participant can be warned. The release of the warning blinking device can be continuous or can be released only during occurrence of the first, second or third input signal.

In general it should be mentioned that the above described conditions of a horn activation, a brake activation or a radar detection can be combined in any way with the condition of the turned-on headlight individually or jointly.

The novel features which are considered as characteristic for the present invention are set forth in particular in the appended claims.

### DESCRIPTION OF THE PREFERRED EMBODIMENTS

An embodiment of a device for preventing animal casualties from a vehicle is presented herein below. The inventive device is preferably used in darkness.

In accordance with the preferable embodiment, the device for preventing animal casualties includes a control-and regulating device which contains a first, a second and a third input signal. The first input signal is the position of the light switch of the vehicle, the second input signal is the position of the horn of the vehicle, and the third input signal is the availability of an actuation of an ABS brake system.

When the first input signal indicates that the light switch is located in a high beam position and the second input signal provides that a driver activates the horn of the vehicle, it can be excluded with a high probability that an animal is located on the roadway. With inputting of the both input signals the control-and regulating device turns off the high beam and turns on the low beam. Thereby, in accordance with the present invention it is achieved that a driver in a fast and simple manner can provide the activation of the horn and also the dimming of the vehicle during a frightening situation of occurrence of an animal on the roadway.

In a further variation of the invention, with availability of the first of the both input signals (high beam and strong braking signal) the horn of the vehicle is automatically actuated. Thereby the probability of an animal casualty is significantly reduced, since the animal is no longer blinded, and because of the activation of the horn it is scared, so that it leaves the roadway. For example it is also possible when the control-and regulation system not continuously actuates a horn, but instead a horn tone is produced in intervals or a horn signal is produced in an ultra-sound region to additionally scare the animal.

The inventive device can be formed so that the control-and regulating device is designed so that during occurrence of the second input signal (actuation of the horn) and/or during occurrence of the third input signal (braking in ABS regulating region or strong braking activation over a predetermined value) automatically the high beam is turned off and the low beam is turned on.

The inventive control-and regulating device can be formed as a simple circuit, which in the inventive occurrence of at least two input signals automatically turns off the high beam and turns on the low beam.

It will be understood that each of the elements described above, or two or more together, may also find a useful application in other types of constructions differing from the types described above.

While the invention has been illustrated and described as embodied in device for preventing animal casualties with a vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for preventing animal casualties from a vehicle, in particular in darkness, comprising a control-and regulating means which obtains at least a first input signal and a second input signal, wherein the first input signal indicates a position of a light switch of the vehicle, so that when the position of the light switch is in a high beam position, said control-and regulating device, in response to obtaining the second input signal, turns off a high beam and turns on a low beam.

2. A device as defined in claim 1, wherein the second input signal is a position of the horn of the vehicle, and the control-and regulating means turns off the high beam and turns on the low beam, when the second input signal indicates an activation of the horn.

3. A device as defined in claim 2, and said control-and regulating means is formed so that a signal of an ABS braking system is obtained as a third input signal, and said control-and regulating means turns off the high beam and turns on the low beam when the third input signal indicates a braking in an ABS control region of the braking system over a predetermined value.

4. A device as defined in claim 1, wherein the second input signal is an actuation of an ABS braking system, said control-and regulating means being formed so that it turns off a high beam and turns on a low beam when the second input signal indicates a braking in an ABS regulating region of a braking system or a braking over a predetermined value.

5. A device as defined in claim 4, wherein said control and regulating system is formed so that it obtains a signal of a horn as a third input signal, said control-and regulating means being formed so that it turns off a high beam and turns on a low beam when said third input signal indicates an actuation of the horn.

6. A device as defined in claim 1, wherein the second input signal is a signal of a radar unit of the vehicle, said control-and regulating means being formed so as to turn off a high beam and to turn on a low beam when the second input signal indicates an availability of life or objects on the roadway.

7. A device as defined in claim 6, wherein said control-and regulating means is formed so that a signal of an ABS braking system or a horn is obtained as a third input signal, said control-and regulating means being formed so as to turn off a high beam and to turn on a low beam when said third input signal indicates a braking in an ABS regulating region of the braking system or a braking over a predetermined value or an actuation of the horn.

8. A device as defined in claim 1, wherein said control-and regulating means is formed so that it retains the low beam turned on continuously.

9. A device as defined in claim 1, wherein said control-and regulating means is formed so that it additionally turns on a warning blinking device of the vehicle.

10. A device as defined in claim 1, wherein said control-and regulating means activates a horn or an additional acoustic signal transducer of the vehicle.

11. A device as defined in claim 10, wherein said additional acoustic signal transducer is a horn in an ultrasound region.
